(19) United States
(12) Patent Application Publication
(10) Pub. No.: US 2025/0153389 A1
(43) Pub. Date: May 15, 2025

(54) SAW DEVICE AND METHOD

(71) Applicant: Festool GmbH, Wendlingen (DE)

(72) Inventors: Sibylle RAPP, Eislingen (DE); Philipp EISENMANN, Bissingen (DE); David MESSER, Zell unter Aichelberg (DE); Andreas WELKER, Nürtingen (DE)

(21) Appl. No.: 18/835,300

(22) PCT Filed: Feb. 2, 2023
(86) PCT No.: PCT/EP2023/052564

§ 371 Date: Aug. 1, 2024

(30) Foreign Application Priority Data
Feb. 3, 2022 (DE) 10 2022 201 167.8

(51) Int. Cl. B27G 19/08; B27G 19/02

(52) U.S. Cl. CPC B27G 19/08; B27G 19/02

(57) ABSTRACT

A sawing device, in particular a circular saw bench, having a saw blade, a riving knife receptacle and a riving knife, which can be inserted into the riving knife receptacle in order to assume a work position behind the saw blade. The sawing device has a locking mechanism which can be set into a locking state by an insertion movement, directed in an insertion direction, of the riving knife into the riving knife receptacle, in which locking state the riving knife is locked by the locking mechanism in the riving knife receptacle with respect to a removal direction opposite to the insertion direction.

The invention relates to a saw device, in particular to a bench saw, with a saw blade, a riving knife receiver and a riving knife which can be inserted into the riving knife receiver, in order to assume a working position behind the saw blade.

Conventionally, a riving knife is fixedly clamped after the insertion into the riving knife receiver. The clamping is effected e.g. by way of a screw, a lever or an eccentric. As a rule, an individual actuation—thus an actuation additionally to the insertion of the riving knife—is necessary for the clamping and hence a further hand manipulation by the user.

It is an object of the invention to provide a saw device which is simpler to operate.

This object is achieved by a saw device according to claim 1. The saw device comprises a locking mechanism which by way of an insertion movement of the riving knife into the riving knife receiver, said insertion movement being directed in an insertion direction, can be brought into a locking state, in which the riving knife by way of the locking mechanism is locked in the riving knife receiver with regard to a removal direction which is opposite to the insertion direction.

Consequently, the riving knife can be inserted into the riving knife receiver and be locked in this by way of one and the same hand actuation of the user, in particular by way of one and the same hand manipulation or working step. The user carries out the insertion movement with the riving knife (for example by way of the user inserting the riving knife by hand into the riving knife receiver) and by way of this effects the locking mechanism locking the riving knife in the riving knife receiver. The locking of the riving knife is herewith effected automatically on inserting the riving knife into the riving knife receiver, without the user (additionally to the insertion movement) having to carry out a further actuation for this. The user thus requires fewer manipulations by hand for operating the saw device, so that the saw device is simpler to operate.

In particular, no tool is necessary for locking the riving knife in the riving knife receiver. The locking mechanism expediently permits a tool-free fastening of the riving knife in the riving knife receiver.

Preferably, the riving knife therefore in a tool-free manner can be attached to the riving knife receiver of the saw device which in particular is designed as a bench saw, i.e. be inserted and locked, in particular by way of a single working step. In this manner, the user can easily assemble the riving knife.

Advantageously, the locking of the riving knife is effected automatically on attaching the riving knife after the riving knife has been completely inserted into the riving knife receiver, for example by way of a spring-biased mechanism.

The spring-biased mechanism can be actuated by the riving knife on inserting into the riving knife receiver, in order to engage into a recess of the riving knife. In particular, the spring-biased mechanism can be firstly pushed back by the riving knife on inserting, in order to then engage into the recess of the riving knife.

Advantageous further formations are the subject-matter of the dependent claims.

The invention further relates to a method for operating the saw device, comprising the step: carrying out the insertion movement of the riving knife into the riving knife receiver, in order by way of this to bring the locking mechanism into the locking state.

Further exemplary details as well as exemplary embodiments are explained hereinafter with reference to the figures. There are shown

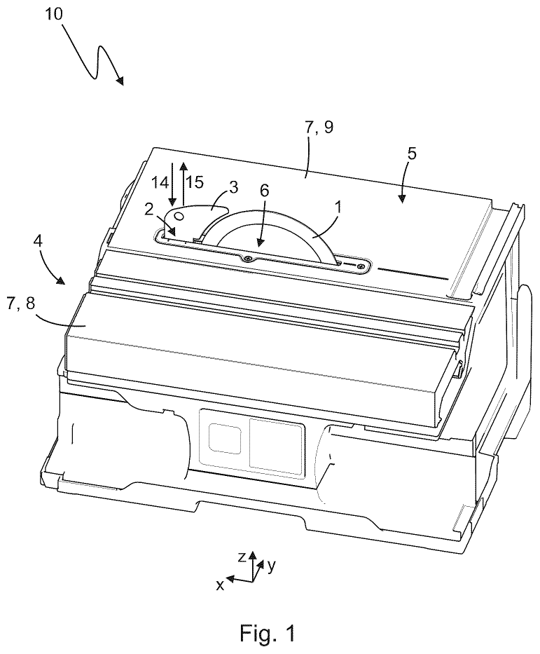

FIG. 1 a perspective representation of a saw device,

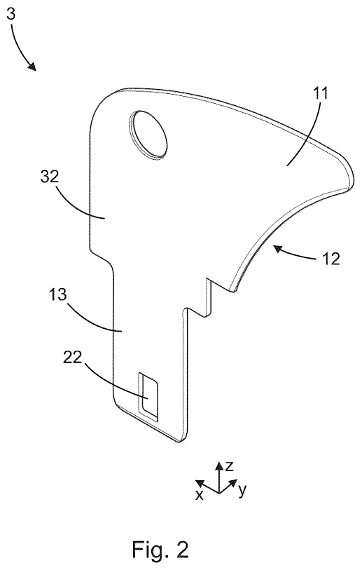

FIG. 2 a perspective representation of a riving knife,

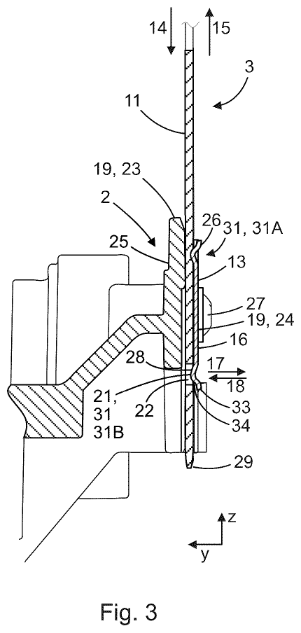

FIG. 3 a sectioned representation of a locking mechanism according to a first variant,

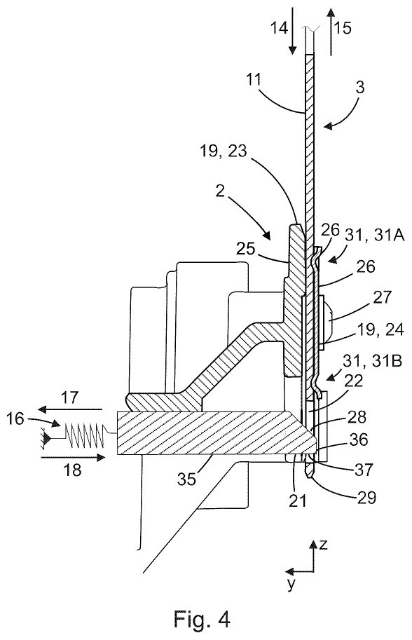

FIG. 4 a sectioned representation of a locking mechanism according to a second variant,

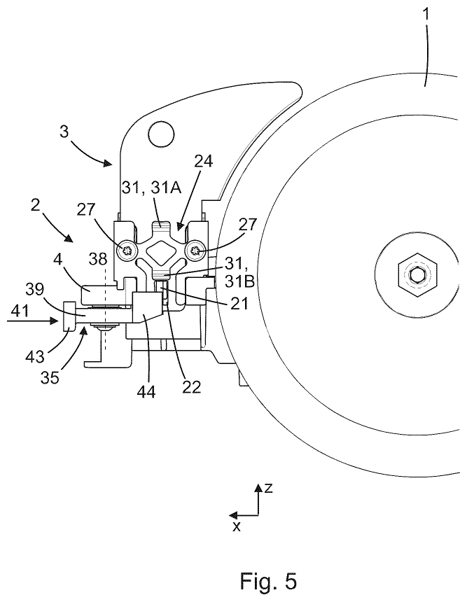

FIG. 5 a plan view of the locking mechanism according to the second variant,

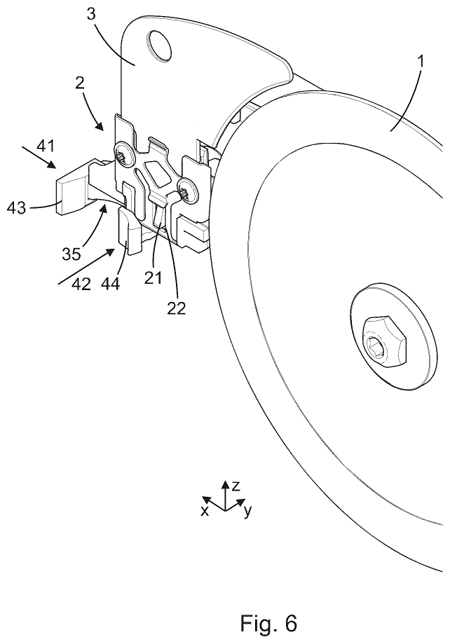

FIG. 6 a perspective view of the locking mechanism according to the second variant,

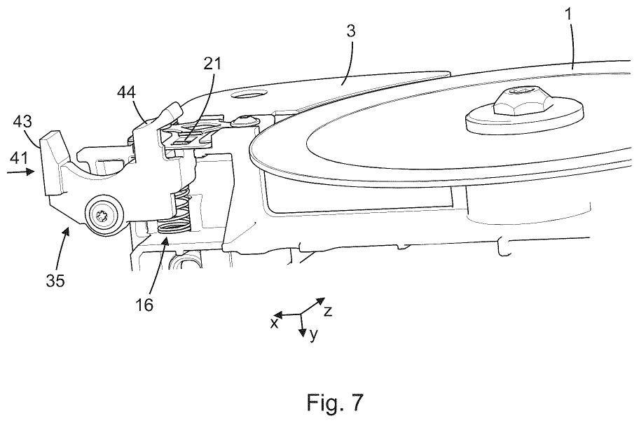

FIG. 7 a perspective view from below upon the locking mechanism according to the second variant,

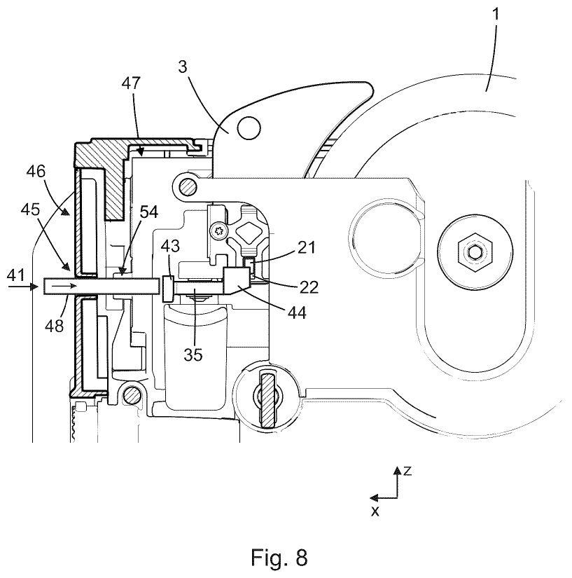

FIG. 8 a sectioned representation of the saw device with the locking mechanism according to the second variant,

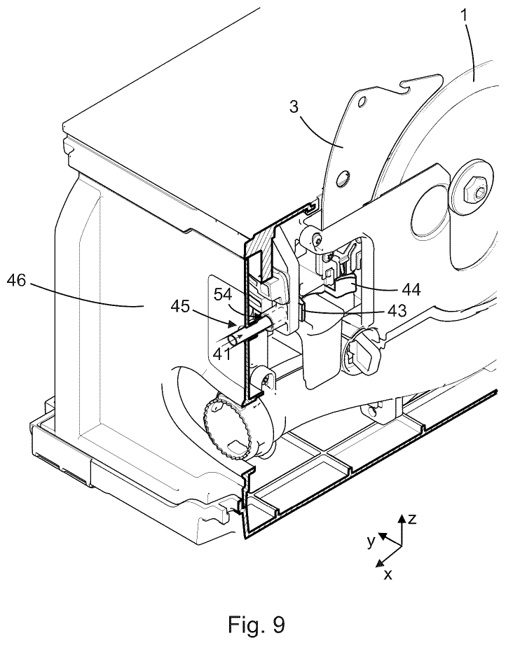

FIG. 9 a perspective sectioned representation of the saw device with the locking mechanism according to the second variant,

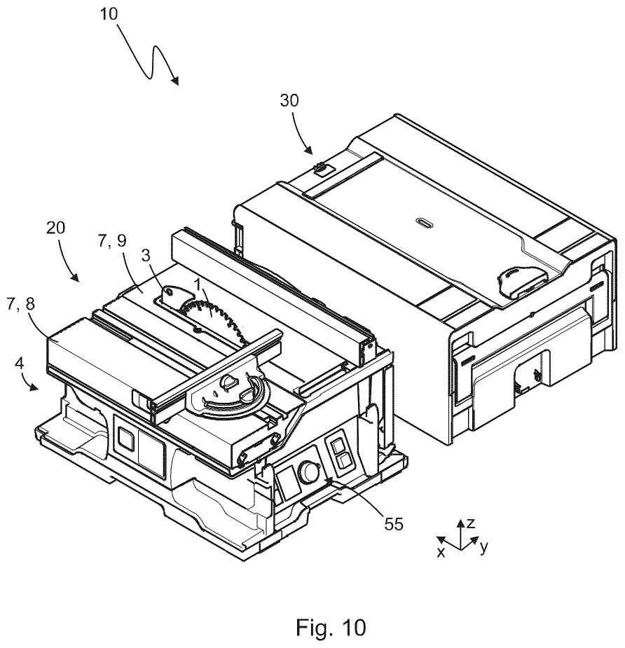

FIG. 10 the saw device with a saw unit and a cover element, and

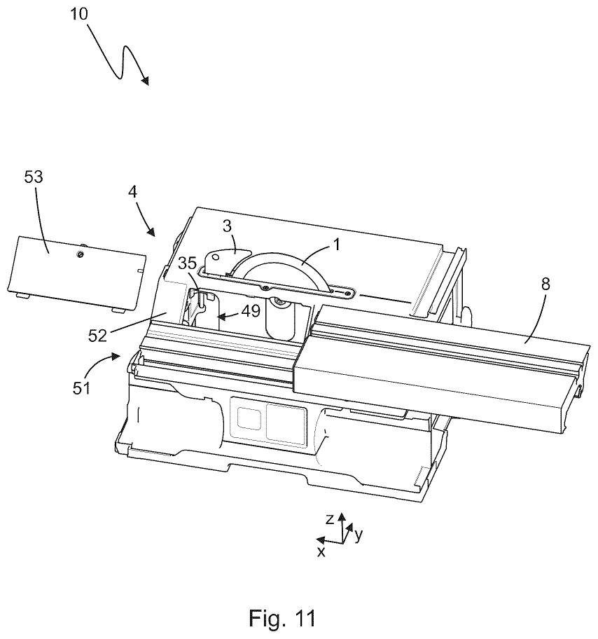

FIG. 11 the saw device with the locking mechanism according to the second variant and with a pulled-out table section.

FIG. 1 shows an exemplary design of a saw device 10. The saw device 10 is preferably designed as a bench saw.

The saw device 10 comprises a saw blade 1, a riving knife receiver 2 and a riving knife 3. The riving knife 3 can be inserted into the riving knife receiver 2, in order to assume a working position behind the saw blade 1. In FIG. 1, the riving knife 3 is shown in the working position. Expediently, the riving knife 3 can be completely removed from the saw device 10.

The x-direction, y-direction and z-direction which are drawn in the figures are referred to in the subsequent explanation. The x-direction and the y-direction are horizontal directions and are aligned orthogonally to one another. By way of example, the x-direction is aligned in the direction of a feed direction in which a workpiece is pushed onto the saw blade 1, in order to saw the workpiece. The y-direction by way of example is aligned orthogonally to the saw blade plane. The z-direction by way of example is a vertical direction and is aligned orthogonally to the x-direction and to the y-direction.

In the working position, the riving knife 3 is arranged behind the saw blade 1 in the x-direction. In the working position, the riving knife 3 is arranged in the saw blade plane. In the working position, the riving knife 3 serves for preventing the saw blade from getting jammed into the workpiece on sawing the workpiece.

The saw device 10 comprises a support structure 4 with which the saw device 10 can be expediently placed on a base surface. By way of example, the support structure 4 has a cuboid basic shape. By way of example, the support structure 4 comprises an outer housing which expediently provides the peripheral sides of the saw device 10. The support structure 4 comprises a rest side 5, on which the workpiece can be placed on sawing the workpiece. By way of example, the rest side 5 is the upper side of the support structure 4. The rest side 5 has a rest side opening 6, from which the saw blade 1 projects out of the support structure 4. By way of example, the rest side opening 6 comprises a section which lies behind the saw blade 1 in the x-direction and which forms an access opening of the riving knife receiver 2. The riving knife 3 and the saw blade 1 project upwards in the z-direction out of the rest side 5, in particular out of the rest side opening 6.

The support structure 4 comprises a rest table 7 which provides the rest side 5. By way of example, the rest table 7 comprises a movably mounted table section 8 which is displaceable relative to the saw blade 1 and to the riving knife 3 in the x-direction. Expediently, the rest table 7 comprises a stationary table section 9, from which the saw blade 1 and the riving knife 3 projects.

FIG. 2 shows an exemplary design of the riving knife 3. The riving knife 3 is designed in a flat, in particular plate-like manner. The y-extension of the riving knife 3 is a multiple smaller than the x-extension and/or the z-extension of the riving knife 3. The riving knife 3 comprises two side surfaces 32 which are aligned opposite to one another and which with regard to surface area are the largest sides of the riving knife 3 and by way of example are aligned perpendicular to the y-direction. The riving knife 3 comprises a riving section 11 with a riving edge 12 which is directed onto the saw blade 3 (in the working position). On sawing the workpiece with the saw blade 1, the workpiece is pushed with the already sawn cutting gap onto the riving knife 3, in particular onto the riving edge 12, in order by way of this to prevent the saw blade 1 getting jammed in the cutting gap. The riving edge 12 by way of example has a concave course. In the working position, the riving section 11 is located above the rest side 5 and in particular is aligned in a flush manner to the saw blade 1, in particular to the saw blade plane.

The riving knife 3 comprises an insertion section 13 which expediently connects at the bottom onto the riving section 11. In the working position, the insertion section 13 is inserted into the riving knife receiver 2.

The saw device 10 comprises a locking mechanism which has a first locking section 21 and a second locking section 22 and in particular serves for the vertical locking of the riving knife 3 in the riving knife receiver 2.

By way of example, the riving knife 3 comprises the second locking section 22 which by way of example is designed as a locking recess, in particular as a locking opening, preferably in the insert section 13. The locking opening by way of example runs from the one side surface 32 to the other side surface of the riving knife 3.

The riving knife receiver 2 is dealt with hereinafter in detail with reference to the FIGS. 3 and 4.

The riving knife receiver 2 preferably comprises an alignment arrangement 19. The alignment arrangement 19 serves for aligning the riving knife 3 relative to the saw blade 1, in particular in a manner such that the riving knife 3 with its riving knife plane lies in the saw blade plane. The riving knife plane is the plane in the middle between the side surfaces 32. Preferably, the alignment arrangement 19 aligns the riving knife 3 in a manner such that the riving knife 3 with its riving knife plane is aligned perpendicularly to the y-direction.

The alignment arrangement 19 preferably comprises a first alignment element 23 and/or a second alignment element 24. The first alignment element 23 preferably provides a first alignment section 25, on which the riving knife 3 bears when it is located in the riving knife receiver 2. The first alignment section 25 for example is a first alignment surface and is preferably aligned perpendicularly to the y-direction. The first alignment surface can also be denoted as a firm riving knife holder side. The second alignment element 24 preferably provides a second alignment section 26, on which the riving knife 3 bears when it is located in the riving knife receiver 2. The second alignment section 26 can be designed as a plurality of support points and/or a second alignment surface. The second alignment section 26 expediently provides as support perpendicular to the y-direction and/or is preferably aligned perpendicularly to the y-direction. The first alignment section 25 and the second alignment section 26 by way of example are aligned oppositely to one another and or arranged lying opposite. The first alignment element 23 by way of example is designed as a fastening flange. The second alignment element 24 is designed for example as a plate, in particulars as a clamping plate. The second alignment element 24 is expediently designed in an elastic manner. The clamping plate is for example a spring plate. Preferably, the second alignment element 24 has a higher elasticity than the first alignment element 23.

Preferably, the alignment arrangement 19 provides a guide, in particular a positive-fit, by way of which the riving knife 3 is aligned in the cutting direction of the saw blade 1, in particular in a manner such that the riving knife 3 cannot be rotated or tilted with respect to the saw blade 1, in particular about an axis parallel to the rotation axis of the saw blade. Expediently, the alignment arrangement 19 serves for preventing the riving knife 3 from being able to be displaced, in particular in the longitudinal direction.

The first alignment element 23 and/or the second alignment element 24 are expediently part of the support structure 4 and/or are connected to the support structure 4. By way of example, the second alignment element 24 is fastened to the first alignment element 23, in particular by way of a fastening element 27, for example a screw.

The riving knife receiver 2 comprises a receiving gap for receiving the riving knife 3. The receiving gap by way of example is defined by the first alignment section 25 and the second alignment section 26. In particular, the receiving gap is located between the first alignment section 25 and the second alignment section 26. In the working position the riving knife 3 is inserted into the receiving gap.

By way of example, the riving knife 3 in the receiving gap is pressed against the first alignment element 23 by the second alignment element 24 which in particular is designed as a clamping plate, and by way of this is clamped in the receiving gap between the two alignment elements 23, 24, in particular in a direction perpendicularly to the first alignment surface and/or in the y-direction.

In particular, the second alignment element 24 comprises at least one clamping section 31 which is preferably designed as a bulge and which presses the riving knife 3 in the receiving gap against the first alignment element 23. By way of example, the second alignment element 24 comprises a first clamping section 31A and a second clamping section 31B which are expediently designed as bulges which are distanced to one another and each in particular project in the direction towards the first alignment element 23. The clamping sections 31A, 31B can form the aforementioned support points. By way of example, the first clamping section 31A (in particular in a removal direction 15 and/or in the z-direction) is arranged above the second clamping section 31B. The first clamping section 31A can also be denoted as an upper clamping section and the second clamping section 31B as a lower clamping section.

In particular, the at least one clamping section 31 projects into the receiving gap with respect to the remaining second alignment element 24, so that the at least one clamping section 31 on inserting the riving knife 3 is moved by the riving knife 3 in the direction away from the first alignment element 23 amid in particular elastic deformation of the second alignment element 24 and presses the riving knife 3 against the first alignment element 23 on account of the elastic deformation.

By way of example, the clamping plate is fixedly screwed in particular to the first alignment element 23. Given the insertion movement, the riving knife 3 is pushed in between the firm riving knife holder side which is provided by the first alignment element 23, and the clamping plate and by way of this is positively aligned in the saw blade plane. The clamping plate comprises the two clamping sections 31 which in particular are designed in a resilient manner and press the riving knife onto the firm riving knife holder side and by way of this expediently provide a clamping, in particular passive clamping of the riving knife 3.

The locking mechanism is dealt with in more detail hereinafter. As explained in more detail hereinafter, the locking mechanism by way of example can be designed according to a first variant (shown in FIG. 3) or a second variant (shown in FIGS. 4 to 9). It is firstly the features which can be present with both variants which are dealt with hereinafter.

The saw device 10 comprises the locking mechanism. The locking mechanism can be brought into a locking state by way of an insertion movement of the riving knife 3 into the riving knife receiver 2, said movement being directed in an insertion direction 14.

The insertion movement can be carried out for example manually by a user, in particular by way of the user gripping the riving knife 3 by hand and pushing it by hand into the riving knife receiver 2, in particular into the receiving gap. The insertion movement is preferably a linear movement. Preferably, the insertion movement is effected vertically downwards. Preferably, the insertion direction 14 has a direction component to the bottom-thus by way of example in the negative z-direction. Preferably, the insertion movement has at least a component perpendicular to the rest side 5. The insertion direction 14 is preferably the negative z-direction.

Preferably, an activation of the locking mechanism is effected by the insertion movement. In particular, the locking mechanism is activated automatically by the insertion movement. Expediently, the locking mechanism is automatically brought into the locking state by way of the insertion movement, in particular starting from an unlocking state.

In the locking state, the riving knife 3 by way of the locking mechanism is locked in the riving knife receiver with respect to a removal direction 15 which is opposite to the insertion direction 14. In the locking state the riving knife 3 is expediently not removable from the riving knife receiver 2, in particular not in the removal direction 15. In particular, the locking mechanism in the locking state blocks a removal movement of the riving knife 3 which is directed in the removal direction 15. The removal movement is preferably a linear movement. The removal movement is preferably effected vertically upwards. The removal direction 15 preferably has a direction component to the top-thus by way of example in the positive z-direction. The removal direction 15 is preferably the positive z-direction.

Expediently, in the locking state the locking of the riving knife 3 is provided additionally to the clamping of the riving knife 3 in the receiving gap which has been explained above. The locking is therefore given in particular additionally to the clamping.

By way of example, the locking mechanism comprises the movably mounted first locking section 21 and the second locking section 22. The first locking section 21 is preferably designed as a locking projection, in particular as a locking projection of the riving knife receiver 2. The second locking section 22 is preferably designed as a locking recess, in particular as a locking recess of the riving knife 3.

The first locking section 21 can be brought into a locking position by the insertion movement. The first locking section 21 assumes the locking position in the locking state. Preferably, in the locking position the first locking section 21 is in engagement with the second locking section 22 and by way of this locks the riving knife 3 in the riving knife receiver 2 with respect to the removal direction 15. For example, in the locking position the first locking section 21 which is designed as a locking projection engages into the second locking section 22 which is designed as a locking recess. In particular, in the locking position the first locking section 22 blocks the second locking section 22, in particular the riving knife 3, in the removal direction 15. By way of example, the first locking section 21 and the second locking section 22 in the locking state form a positive fit which acts in the removal direction, in order by way of this to lock the riving knife 3 in the riving knife receiver 2 with respect to the removal direction 15. For example, the first locking section 21 and the second locking section 22 are positively connected to one another in the locking state.

Preferably, the locking mechanism comprises a spring section 16. The locking mechanism is designed to bring the first locking section 21 into the locking position amid the use of a spring force which is provided by the spring section 16, as a response to the insertion movement.

By way of example, the locking mechanism is designed, in a first movement phase of the insertion movement, to convert the insertion movement of the riving knife 3 into a biasing movement of the first locking section 21, in order by way of this to bias the spring section 16 and thus to provide the spring force, and after completion of the first movement phase to bring the first locking section 21 into the locking position amid the use of the spring force. The biasing movement by way of example is effected in a biasing direction 17 which is different to the insertion direction. The biasing direction 17 for example can have a horizontal component, in particular a y-component. For example, the biasing direction 17 is the positive y-direction or the negative y-direction. Expediently, the first locking section 21 executes a locking movement which is directed in a locking direction 18, in order to assume the locking position. The locking direction 18 is aligned oppositely to the biasing direction 17.

Optionally, by way of a release movement of the riving knife which is directed in the insertion direction, the locking mechanism can be brought from the locking state into an unlocking state, in which the riving knife is not locked with respect to the removal direction and after the release movement can be removed from the riving knife receiver by way of a removal movement which is directed in the removal direction. Preferably, the first locking section is brought into a biasing position by way of the release movement (before the removal movement), in order by way of this to bias the spring section 16 and to provide a spring force and to unlock the riving knife. Optionally, after completion of the insertion movement, the first locking section 21 is brought into the locking position amid the application of spring force.

Preferably, the first locking section 21 comprises a first contact section 28 which by way of example is designed as a first contact surface and/or the second locking section 22 comprises a second contact section 29 which by way of example is designed as a first contact edge. The second contact section 29 by way of example is located at the lower end of the riving knife 3. By way of example, the first contact surface is angled relative to the insertion direction 14, in particular at an angle of larger than 0 degrees and smaller than 90 degrees. The first contact surface in particular is aligned normally to a y-z direction (wherein the y-component and the z-component are each positive). On account of the angle of the first contact surface, the insertion movement of the first contact edge which presses against the first contact surface is converted into the biasing movement. By way of example, the first contact surface and the first contact edge are arranged at an acute angle to one another, so that the first contact edge which presses against the first contact surface on account of the insertion movement creates the biasing movement.

In the first movement phase of the insertion movement, the second contact section 29 presses onto the first contact section 28 and by way of this effects the biasing movement of the first locking section 21. The locking section 21 is brought into a biasing position by the biasing movement. The first locking section 21 in the biasing position bears on the riving knife 3 and by way of example presses (on account of the spring force of the spring section 16) against the riving knife 3, in particular in the locking direction 18. In this state, the riving knife 3 (whilst executing the insertion movement) is moved further in the insertion direction 14 relative to the first locking section 21 until the second locking section 22 (by way of example designed as a locking recess) reaches the first locking section 21 due to the insertion movement, so that the first locking section 21 on account of the spring force of the spring section 16 engages into the second locking section 22, in particular latches, preferably snaps into this, by which means expediently the locking mechanism is brought into the locking state. The latching provides the user with feedback on the reliable assembly of the riving knife 3 and holds the riving knife 3 in the vertical direction in a reliably positioned manner.

Hereinafter, the first variant of the locking mechanism which is shown in FIG. 3 is dealt with in more detail. By way of example, the first locking section 21 is part of the second alignment element 24. In particular, the first locking section 21 is a section of the second alignment element 24 which is designed as a clamping plate. For example, the first locking section 21 comprises a (in particular projecting in the y-direction) bulge of the clamping plate. In particular, the first locking element 21 is the clamping section 31, by way of example the lower clamping section 31B.

Preferably, the spring section 16 is an elastically deformable section of the clamping plate, for example a section of the clamping plate which lies between the first locking element 21 and the fastening element 27.

The state in which the riving knife 3 with its insertion section 13 is inserted completely into the riving knife receiver is also to be denoted as a completely inserted state of the riving knife 3. By way of example, in the completely inserted state of the riving knife 3, the lower clamping section 31B engages into the second locking section 22 which is designed as a recess in the riving knife 3, by which means a latching of the riving knife 3 in the riving knife receiver 2 is expediently effected.

Preferably, the locking mechanism can be brought from the locking state into an unlocking state by way of a first movement phase of a removal movement of the riving knife 3, said first movement phase being carried out with at least a predefined unlocking force. The removal movement is directed in the removal direction 15. In the unlocking state the riving knife 3 is not locked with respect to the removal direction 15 and after the first movement phase of the removal movement can be removed out of the riving knife receiver 2 by way of a second movement phase of the removal movement and expediently completely removed from the saw device.

The first locking section 21 expediently comprises a third contact section 33. which in particular is designed as a second contact surface. For example, the third contact section 33 is an angled surface of the bulge of the clamping plate. The second locking section 22 expediently comprises a fourth contact section 34 which in particular is designed as a second contact edge. For example, the fourth contact section 34 is an edge of the recess of the riving knife. The angled surface in particular is aligned normally to a y-z direction (wherein the y-component is positive and the z-component is negative). In the first movement phase of the removal movement, the fourth contact section 34 presses against the third contact section 33 and by way of this effects the release of the positive fit which acts in the removal direction 15, between the first locking section 21 and the second locking section 22, in particular by way of the first locking section 21 being moved out of the second locking section 22. By way of example, given the first movement phase of the removal movement, the second contact edge presses against the second contact surface, by which means the bulge of the clamping plate is pressed in the horizontal direction—by way of example in the negative y-direction—and by way of this is moved out of the recess of the riving knife 3.

The unlocking force which is required for the first movement phase of the removal movement is expediently larger than a removal force which is required for the second movement phase of the removal movement. Expediently, the unlocking force needs to be large enough in order to elastically deform the clamping plate such that the bulge is moved out of the recess of the riving knife. The removal force expediently needs to be large enough in order to overcome the clamping which is provided by the clamping plate.

Advantageously, the unlocking force which is necessary for the first movement phase of the removal movement is larger than the insertion force which is required of the first movement phase of the insertion movement. This is expediently achieved by way of the first contact section 28 having a shallower angle to the insertion direction 14 than the third contact section 33. In particular, the relative angle of the first contact section 28 to the second contact section 29 is shallower than the relative angle of the third contact section 33 to the fourth contact section 34.

With regard to the variant of the locking mechanisms which is discussed above, the riving knife 3 can be unlocked and removed from the riving knife receiver by one and the same hand actuation—in particular by one and the same hand manipulation.

A saw device 10 with a locking mechanism according to the first variant can be operated as follows. The user grips the (not yet located in the riving knife receiver 2) riving knife 3 and whilst carrying out the insertion movement pushes the riving knife 3 with the insertion section 13 into the riving knife receiver 2 until the riving knife 3 is completely inserted into the riving knife receiver 2 and by way of this the first locking section 21 automatically latches into the second locking section 22 so that the riving knife 3 is positively locked in the riving knife receiver 2. For removal, the user grips the (locked in the riving knife receiver) riving knife 3 and pulls on the riving knife 3 in the removal direction 15, so that by way of this the first locking section 21 is moved out of the second locking section 22 and the riving knife 3 is thus unlocked. The user then pulls the unlocked riving knife 3 out of the riving knife receiver 2 in the removal direction 15 and expediently completely removes the riving knife 3 from the saw device 10.

The second variant of the locking mechanism which is shown in FIG. 4 is hereinafter dealt with in more detail.

Preferably, the locking mechanism comprises a locking element 35 which by way of an unlocking movement can be brought into an unlocking position, in order to bring the locking mechanism into the unlocking state. In the unlocking state, the riving knife 3 is not locked with respect to the removal direction 15 and after the unlocking movement of the locking element 35 can be removed from the riving knife receiver 2 by way of a removal movement which is directed in the removal direction 15.

By way of example, the direction of the unlocking movement is different from the removal direction 15. In particular, the direction of the unlocking movement is a horizontal direction and preferably has a positive y-component. The direction of the unlocking movement is for example the biasing direction 17.

Expediently, the locking mechanism for carrying out the unlocking movement requires an actuation by hand additionally to an actuation by hand necessary for the removal movement. The user thus by way of example requires two different hand grips or movements in order to unlock the riving knife 3 and remove it from the riving knife receiver.

By way of example, the locking element 35 represents a spring-biased locking, by way of which the riving knife 3 is secured in the riving knife receiver 2, in particular in a manner such that a pulling of the riving knife 3 out of the riving knife receiver is prevented, and in particular is only possible until after releasing the locking.

The locking element 35 by way of example is part of the riving knife receiver 2. Preferably, the locking element 35 is not part of the second alignment element 24. In particular, the locking element 35 is present additionally to the clamping plate. The spring section 16 by way of example is present additionally to the locking element 35 and/or additionally to the clamping plate.

By way of example, the locking element 35 is arranged in the support structure 4. In particular, the locking element 35 is arranged in the housing of the saw device 10. Expediently, the locking element 35 is arranged such that it cannot be reached by the fingers of the user. As is explained in more detail hereinafter, the locking element 35 is preferably actuatable via two different sides of the saw device 10, in order to bring the locking mechanism into the unlocking state.

In the locking state, the locking element 35 expediently cannot be brought into the unlocking movement by way of applying a force which is directed in the unlocking direction 15. By way of example, the locking element 35 comprises a contact surface 36 which is aligned perpendicularly to the removal direction and which is arranged for example on the lower side of the locking element 35. If one pulls on the riving knife 3 in the removal direction, then a lower contact edge 37 of the recess of the riving knife hits the contact surface 36. On account of the alignment of the contact surface 36 orthogonally to the removal direction 15, the locking element 35 is not brought into the unlocking movement by the lower contact edge 37, so that the locking element 35 remains at its position and the locking state is retained.

An exemplary design of the locking element 35 is dealt with in more detail hereinafter with reference to the FIGS. 5 to 9.

By way of example, the locking element 35 is rotatably mounted, in particular on the support structure 4. By way of example, the locking element is rotatably mounted about a rotation axis 38 which runs in the z-direction. The unlocking movement is expediently a rotation movement of the locking element. Preferably, the biasing movement and/or the locking movement are advantageously a rotation movement. The first locking section 21 which by way of example is designed as a locking projection is arranged offset to the rotation axis 38 (in particular horizontally), so that the first locking section 21 can be pivoted out of the second locking section 22 which in particular is designed as a locking recess, by way of the rotation movement of the locking element 35, in order to provide the unlocking state of the locking mechanism. The first locking section 21 by way of example is designed as a locking lug.

The locking element 35 by way of example comprises a main section 39, through which the rotation axis 38 expediently runs. The first locking section 21 which by way of example projects horizontally (in particular in the negative y-direction) from the main section 39 is arranged on the main section 39. The locking element 35 expediently comprises a first actuation section 43 and/or a second actuation section 44. The first actuation section 43 and/or the second actuation section 44 is expediently designed as a press surface. The first actuation section 43 and/or the second actuation section 44 is expediently arranged on the main section 39, and specifically (in particular horizontally) offset to the rotation axis 38 such that a linear actuation of each actuation section 43, 44 effects the unlocking movement of the locking element 35 which is designed as a rotation movement. The first actuation section 43 comprises a first actuation surface which is aligned normally to the x-direction and/or can be actuated in the (negative) x-direction. The second actuation section comprises a second actuation surface which is aligned normally to the (negative) y-direction and/or can be actuated in the y-direction.

By way of example, the spring section 16 is designed as a helical spring. In particular, the main section 39 is supported on the support structure 4 via the spring section 16.

Preferably, the locking element 35 can be selectively brought into the unlocking movement by way of a first actuation which is directed in a first actuation direction 41 or by a second actuation which is directed in a second actuation direction 42. The first actuation direction 41 differs from the second actuation direction 42. Preferably, the first actuation direction 41 and/or the second actuation direction 42 are a respective horizontal direction. For example, the first actuation direction 41 and the second actuation direction 42 are aligned orthogonally to one another. Preferably, the first actuation direction 41 is the negative x-direction and/or the second actuation direction is the positive y-direction.

The first actuation is expediently an actuation of the first actuation section 43, in particular of the first actuation surface. The second actuation is expediently an actuation of the second actuation section 44, in particular of the second actuation surface.

Preferably, the saw device 10 comprises a first locking element access 45 via which the locking element 35 can be actuated, in order to bring it into the unlocking movement. The first locking element access 45 is shown in the FIGS. 8 and 9.

By way of example, the first locking element access 45 is arranged on a peripheral side 46 of the saw device 10. The peripheral side 46 is for example an outer side of the support structure 4. The peripheral side in particular is an outer side of an outer housing of the saw device 10. The peripheral side 46 is expediently aligned vertically, by way of example normally to the positive x-direction. For example, the first locking element access 45 is an opening in the peripheral side 46.

Preferably, the saw device 10 comprises an adjustment section 47 which comprises the saw blade 1 and the riving knife receiver 2 and can be adjusted in its position in order to set a position of the saw blade 1. The adjustment section 47 can preferably be brought into an access position, in which the locking element 35 can be actuated via the first locking element access 45. Preferably, the adjustment section 47 can be brought into a non-access position, in which the locking element 35 cannot be actuated via the first locking element access 45.

By way of example, each position of the adjustment section which is different to the access position is a non-access position, in which the locking element 35 cannot be actuated via the first locking element access 45.

By way of example, in the access position an imagined straight line which runs through the first locking element access 45 in the first actuation direction 41 hits the first actuation section 43, in particular the first actuation surface. By way of example, in each non-access position, the imagined straight line which runs through the first locking element access 45 in the first actuation direction 41 does not hit the first actuation section 43, in particular does not hit the first actuation surface.

By way of example, an actuation element 48 which in particular is designed in an elongate manner, for example an actuation rod is necessary for actuating the first actuation section 43 via the first locking element access 45. For example, a screwdriver or a hexagonal key can be used as the actuation element 48.

Expediently, in the access position the first actuation section 43 can be actuated by the actuation element 48 via the locking element access 45, in order by way of this to bring the locking element 35 into the unlocking movement. Expediently, in every non-access position, the first actuation section 43 cannot be actuated by the actuation element 48 via the locking element access 45.

Purely by way of example, the adjustment section 47 comprises an adjustment section opening 54 which in the access position is flush with the locking element access in the first actuation direction 41, so that the actuation element 48 can be introduced through the adjustment section opening 54 in the first actuation direction 41 via the locking element access, in order to actuate the first actuation section 43 and by way of this to bring the locking element into the unlocking movement. Preferably, in every non-access position the adjustment section opening 54 is not flush with the locking element access in the first actuation direction 41, so that the actuation element 48 cannot be introduced through the adjustment section opening 54 in the first actuation direction 41 via the locking element access.

The saw device 10 preferably comprises an electrical adjustment unit, via which the adjustment section 47—and herewith the saw blade 1, the riving knife receiver 2 and the riving knife 3 which is inserted into the riving knife receiver 2—can be changed together in their position. By way of example, the saw device 10 comprises an operating device 55, via which a user can carry out a user input, which has the effect of the adjustment unit 47 bringing the adjustment section 47 into the access position. For example, the user input is effected by a key push or via the selection of a menu point on a display of the saw device 10.

By way of example, the saw blade 1 assumes a transport position in the access position of the adjustment section 47. FIG. 10 shows an exemplary design of the saw device 10 with a cover element 30 which in particular is designed in a hood-like manner. The saw device 10 without the cover element 30 is to be denoted as a saw unit 20. The saw unit 20 comprises the saw blade 1, the riving knife receiver 2, the riving knife 3 and the support structure 4. In the access position of the adjustment section 47, the cover element 30 expediently can be placed completely onto the saw unit 20 and in particular can be fastened on this, in order to bring the saw device 10 into a transport configuration. In a non-access position, the cover element 30 (in particular on account of the saw blade 1) expediently cannot be completely placed upon the saw unit 20 and/or cannot be fastened on this, so that the saw device 10 cannot be brought into the transport configuration

By way of example, the saw device 10 comprise a second locking element access 49 which is distanced to the first locking element access 45 and via which the locking element 35 can be actuated, in order to bring it into the unlocking movement. The second locking element access 49 is shown in FIG. 11. By way of example, the second locking element access 49 is arranged on a different side of the saw device 10, in particular of the support structure 4, than the first locking element access 45.

The support structure 4 by way of example comprises a support structure body 51, on which the table section 8 is movably mounted. The support structure body 51 comprises an access surface 52 which in particular is arranged on its upper side and which is preferably covered by the movable table section 8 when the movably table section 8 is located in a retracted position. The access surface 52 by way of example is aligned normally to a y-z direction (wherein the y-component is negative and the z-component is positive). The second locking element access 49 is preferably arranged in the access surface 52 and is designed in particular as an opening in the access surface 52.

By way of example, the saw device 10 comprises a covering 53 which in particular is designed as a cover plate and serves for covering the second locking element access 49.

Preferably, the locking element 35 also in a non-access position of the adjustment section 47 can be actuated via the second locking element access 49 via a user (for example by way of the actuation element 48), in order to bring the locking element 35 into the unlocking movement, in order by way of this to unlock the locking mechanism, so that the riving knife 3 can be removed from the riving knife receiver 2.

In particular, the second locking element access 49 is envisaged for the case in which an actuation of the locking element 35 is not possible via the first locking element access 45, for example if the adjustment section 47 cannot be brought into the access position.

In order to gain access to the second locking element access 49, the user by way of example must firstly bring the movably mounted table section 8 into an extended position and then remove the covering 53 from the second locking element access 49.

A saw device 10 with the locking mechanism according to the second variant can be operated as follows. The user grips the riving knife 3 (not yet located in the riving knife receiver 2) and whilst carrying out the insertion movement pushes the riving knife 3 with the insertion section 13 into the riving knife receiver 2 until the riving knife 3 is completely inserted into the riving knife receiver 2 and by way of this the first locking section 21 automatically latches into the second locking section 22, so that the riving knife 3 is positively locked in the riving knife receiver 2. For removal, the user presses the actuation element 48 through the first locking element access 45 against the first actuation element 43 so that by way of this the first locking section 21 is moved out of the second locking section 22, and the riving knife 3 is therefore unlocked. The user then pulls the unlocked riving knife 3 out of the riving knife receiver 2 in the removal direction 15, and expediently completely removes the riving knife 3 from the saw device 10.

1-19. (canceled)

20. A saw device with a saw blade, a riving knife receiver and a riving knife which can be inserted into the riving knife receiver, in order to assume a working position behind the saw blade, wherein the saw device comprises a locking mechanism which by way of an insertion movement of the riving knife into the riving knife receiver, said insertion movement directed in an insertion direction, can be brought into a locking state, in which the riving knife by way of the locking mechanism is locked in the riving knife receiver with respect to a removal direction which is opposite to the insertion direction.

21. The saw device according to claim 20, wherein the locking mechanism comprises a movably mounted first locking section and a second locking section, wherein the first locking section by way of the insertion movement can be brought into a locking position, in which the first locking section is in engagement with the second locking section and by way of this locks the riving knife in the riving knife receiver which respect to the removal direction.

22. The saw device according to claim 21, wherein the first locking section and the second locking section in the locking state form a positive fit which acts in the removal direction, in order by way of this to lock the riving knife in the riving knife receiver with respect to the removal direction.

23. The saw device according to claim 21, wherein the locking mechanism comprises a spring section and is designed, amid the use of a spring force which is provided by the spring section, to bring the first locking section into the locking position as a response to the insertion movement.

24. The saw device according to claim 23, wherein the locking mechanism is designed to convert, in a first movement phase of the insertion movement, the insertion movement of the riving knife into a biasing movement of the first locking section, in order by way of this to bias the spring section and thus provide the spring force, and after completion of the first movement force to bring the first locking section into the locking position amid the use of the spring force.

25. The saw device according to one of the claim 21, wherein the first locking section is designed as a locking projection and the second locking section is designed as a locking recess.

26. The saw device according to claim 20, wherein the locking mechanism can be brought from the locking state into an unlocking state by way of a first movement phase of a removal movement of the riving knife, said first movement phase being carried out with at least a predefined unlocking force, wherein the removal movement is directed in the removal direction, and wherein the riving knife in the unlocking state is not locked with respect to the removal direction and after the first movement phase of the removal movement can be removed from the riving knife receiver by way of a second movement phase of the removal movement.

27. The saw device according to claim 26, wherein by way of a release movement of the riving knife which is directed in the insertion direction, the locking mechanism can be brought from a locking state into an unlocking state in which the riving knife is not locked with respect to the removal direction and after the release movement can be removed from the riving knife receiver by way of a removal movement which is directed in the removal direction.

28. The saw device according to claim 20, wherein the locking mechanism comprises a locking element which by way of an unlocking movement can be brought into an unlocking position, in order to bring the locking mechanism into an unlocking state, and wherein the riving knife in the unlocking state is not locked with respect to the removal direction and herewith after the unlocking movement of the locking element can be removed out of the riving knife receiver by way of a removal movement which is directed in the removal direction

29. The saw device according to claim 28, wherein the locking element is part of the riving knife receiver.

30. The saw device according to claim 28, wherein the unlocking movement is a rotary movement.

31. The saw device according to claim 28, wherein the locking element can be brought into the unlocking movement selectively by way of a first actuation which is directed in a first actuation direction or a second actuation which is directed in a second actuation direction, wherein the first actuation direction differs from the second actuation direction.

32. The saw device according to claim 28, wherein the saw device comprises a first locking element access, via which the locking element can be actuated, in order to bring it into the unlocking movement.

33. The saw device according to claim 32, wherein the first locking element access is arranged on a peripheral side of the saw device.

34. The saw device according to claim 32, further comprising an adjustment section which comprises the saw blade and the riving knife receiver and can be adjusted in its position, in order to set a position of the saw blade, wherein the adjustment section can be brought into an access position, in which the locking element can be actuated via the first locking element access.

35. The saw device according to claim 34, wherein the adjustment section can be brought into a non-access position, in which the locking element cannot be actuated via the first locking element access.

36. The saw device according to claim 32, wherein the saw device comprises a second locking element access which is distanced to the first locking element access and via which the locking element can be actuated in order to bring it into the unlocking movement.

37. The saw device according to claim 36, wherein the adjustment section can be brought into a non-access position, in which the locking element cannot be actuated via the first locking element access, wherein the locking element in the non-access position can be actuated via the second locking element access.

38. A method for operating a saw device according to claim 20, comprising the step:
carrying out the insertion movement of the riving knife into the riving knife receiver, in order by way of this to bring the locking mechanism into the locking state.

39. The saw device according to claim 20, wherein the saw device is a bench saw.
